(19) United States
(12) Patent Application Publication
(10) Pub. No.: US 2026/0124799 A1
(43) Pub. Date: May 7, 2026

(54) Cooling Device for Plastic Tubular Films

(71) Applicant: Windmöller & Hölscher KG, Lengerich (DE)

(72) Inventors: Carsten RIEMANN, Lingen (DE); Michael SKODZIK, Meppen (DE); Vojtech TELECKY, Bonaduz (CH)

(21) Appl. No.: 19/120,677

(22) PCT Filed: Oct. 18, 2023
(86) PCT No.: PCT/EP2023/078960

§ 371 Date: May 1, 2025

(30) Foreign Application Priority Data
Oct. 18, 2022 (DE) 10 2022 127 349.0

(51) Int. Cl. B29C 48/88; B29C 48/10; B29C 48/32; B29C 48/355; B29C 48/885; B29C 48/89; B29C 48/92

(52) U.S. Cl. CPC B29C 48/912; B29C 48/10; B29C 48/32; B29C 48/355; B29C 48/885; B29C 48/89; B29C 48/92

(57) ABSTRACT

The invention relates to a cooling device for plastic tubular films. In order to increase the cooling capacity of a known cooling device while simultaneously reducing bubble instabilities, the operating distance between the support air unit and the film bubble can be adjusted using at least two driven lifting elements, wherein the lifting elements are coupled together via a coupling element such that the lifting elements produce the same displacement distance upon adjusting the operating distance.

The invention relates to a cooling device for plastic tubular films. The invention also relates to a blown film line for producing plastic tubular films or plastic film webs with a corresponding cooling device.

Such blown film lines are known, for example, from WO 2021/069474 A1 and, according to their basic design, consist of one or more extruders, a film blowing head, a cooling device, a haul-off and one or more winders.

A corresponding film blowing head for such blown film systems is known, for example, from WO 2002/070230 A1.

Corresponding cooling devices for such blown film systems are known, for example, from DE 1 960 962 A1, WO 2008/025451 A1 and EP 2 498 970 B1.

The extruder essentially consists of a metal cylinder in which an extruder screw rotates. The plastic granulate fed to the extruder screw is melted by the friction and pressure in the metal cylinder, homogenized and fed to the film blowing head.

The film blowing head forms the melt streams coming from the extruders into a multi-layer film composite, which then emerges from an annular nozzle gap as a thermoplastic film tube. The annular nozzle gap is formed by an outer and an inner mouth gap ring.

The thermoplastic film tube is inflated with air and fed to the cooling device, in which the film tube is cooled by cooling air from the outside and inside. The width and thickness of the film are also determined in the cooling device in this way. At the so-called frost line or solidification line, the molten mass then changes from a thermoplastic to a thermoelastic state.

The film tube cooled in the cooling device is then laid flat and wound into a film roll on a winder. As a rule, the flattened film tube is cut open at the edges by means of two knife blades, so that two separate film webs are produced, which are also wound separately from each other on two winders. The wound film rolls are then further processed in the desired manner, for example into bags or bin liners.

Depending on the number of extruders connected, there are films that of just one layer (so-called mono blown film) or films that are made up of several layers (so-called coextrusion blown film). With coextrusion blown film, it is possible to combine the positive properties of different materials in one film. For example, a typical food packaging consists of five different layers:
Outside: a printable layer, usually polypropylene or polyethylene
Between outside and center: Adhesion promoter made of ethylene vinyl alcohol or ethylene vinyl acetate.
Center: a polyamide barrier layer to “lock in” the aroma
Between center and inside: Adhesion promoter
Inside: a food-safe layer with good sealing properties to enable the film to be sealed to the bottom part of the packaging, usually made of polyethylene

In the blown film extrusion described above, the cooling device is of particular importance, as the cooling of the thermoplastic film tube emerging from the nozzle gap has a significant influence on both the film properties and the efficiency of the extrusion process.

The cooling devices known from the prior art regularly consist of an external cooling ring and an internal cooling ring. This flow cooled air onto the film tube emerging from the nozzle gap from the outside and inside in order to remove the heat from the thermoplastic melt. An internal exhaust pipe is located inside the film tube to extract the air blown in by the internal cooling ring. A constant internal pressure of the film tube is maintained via a control loop so that the bubble shape can also be kept stable in relation to the extraction speed.

In principle, the cooling device should have the highest possible cooling capacity, as this increases the mass throughput and therefore also the production speed of the system. On the other hand, however, the thermoplastic film tube only has limited strength, so there is a risk of bubbles breaking if the draw-off speed is too high.

To increase the cooling capacity, it is known from EP 2 498 970 B1 to extend the outer cooling ring of the cooling device with a supporting air unit. The supporting air unit of EP 2 498 970 B1 consists of three wooden cylinders with different diameters. The hollow cylinder with the smallest diameter is mounted on the outer cooling ring. The hollow cylinder with the medium diameter is arranged concentrically above it, and the hollow cylinder with the largest diameter in turn forms the end of the supporting air unit above it. The resulting flow conditions between the three stacked wooden cylinders and the film bubble can increase the cooling capacity on the outer wall of the film bubble. To optimize the flow conditions, the axial distances between the three wooden cylinders can also be adjusted, whereby a motorized adjustment option is also mentioned in EP 2 498 970 B1.

Extensive tests with the supporting air unit known from EP 2 498 970 B1 have now shown that although the cooling capacity can be increased with the supporting air unit, the risk of bubble breakage cannot be reduced at the same time.

In addition, when the cooling capacity was increased with the supporting air unit, it was observed that the film quality deteriorated due to inhomogeneities.

The task of the invention is therefore to increase the cooling capacity of a known cooling device while at the same time reducing bubble instabilities.

This problem is solved by the features of claims 1 and 4.

The solution according to the invention is that the operating distance between the supporting air unit and the film bubble can be adjusted using at least two driven lifting elements, the lifting elements being coupled to one another via a coupling element in such a way that the lifting elements effect the same adjustment path when adjusting the operating distance.

The solution according to the invention eliminates the mechanical inaccuracies that arise when adjusting the three hollow cylinders according to EP 2 498 970 B1. With the adjustment options known from EP 2 498 970 B1, the centering and horizontal alignment of the three hollow cylinders with respect to the axial axis of symmetry of the annular nozzle gap cannot be sufficiently ensured. This results in different distances and alignments to the three hollow cylinders of the supporting air unit along the circumference of the film bubble. Areas with a large flow gap then led to lower flow velocities and therefore to poorer cooling performance than areas with smaller flow gaps. In turn, [the film] is stretched longer in the extrusion direction in areas with a large flow gap, which leads to thin spots in the film and thick spots in other areas. This results in inhomogeneities and instabilities in the film.

In the support air unit according to the invention, however, the motorized height adjustment is so precise that the hollow cylinders of the support air unit remain centered and horizontally aligned along the entire adjustment path. This enables the operator to precisely adjust the supporting air unit to the bubble geometry both when setting up the machine and during operation. This makes it possible to adjust small to very small air gaps between the support air unit and the blower geometry. Smaller air gaps in turn increase the flow velocity, whereby the local air pressure decreases.

By increasing the flow velocity while simultaneously reducing the local air pressure, both the heat transfer and the bubble stability can be increased. In addition, the reduced local air pressure allows an earlier expansion of the film bubble within the supporting air unit, whereby a larger film surface is available for heat dissipation.

Further details and advantages of the invention are described with reference to the accompanying drawings. These show:

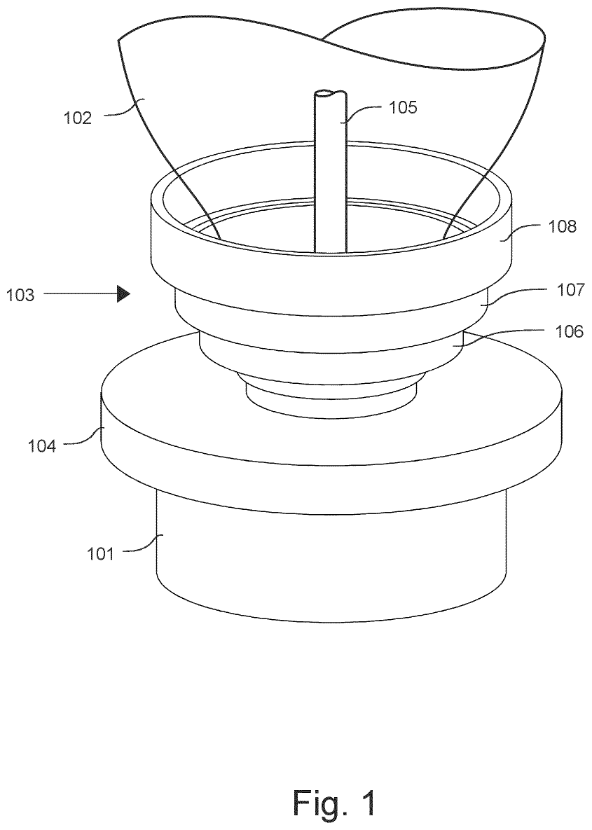

FIG. 1 a schematic 3D view of the cooling device according to the invention,

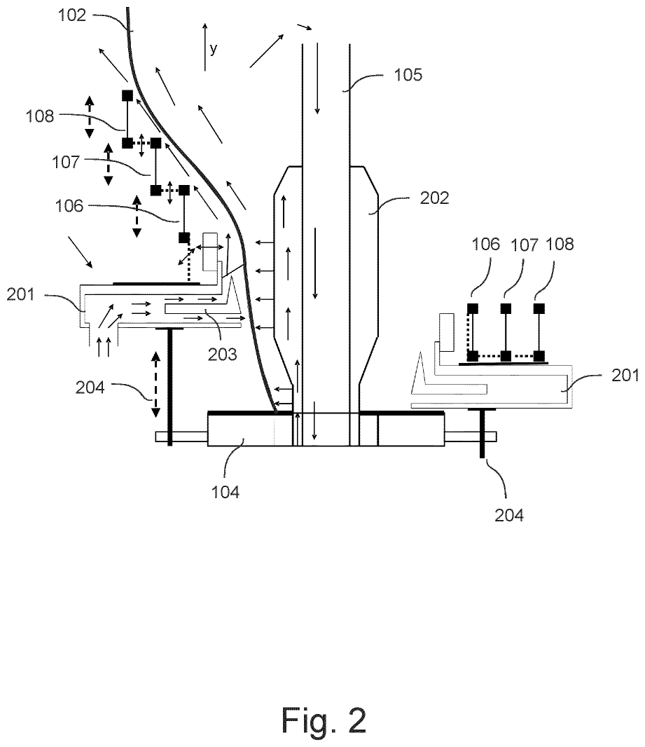

FIG. 2 a side view of the cooling device according to the invention, and

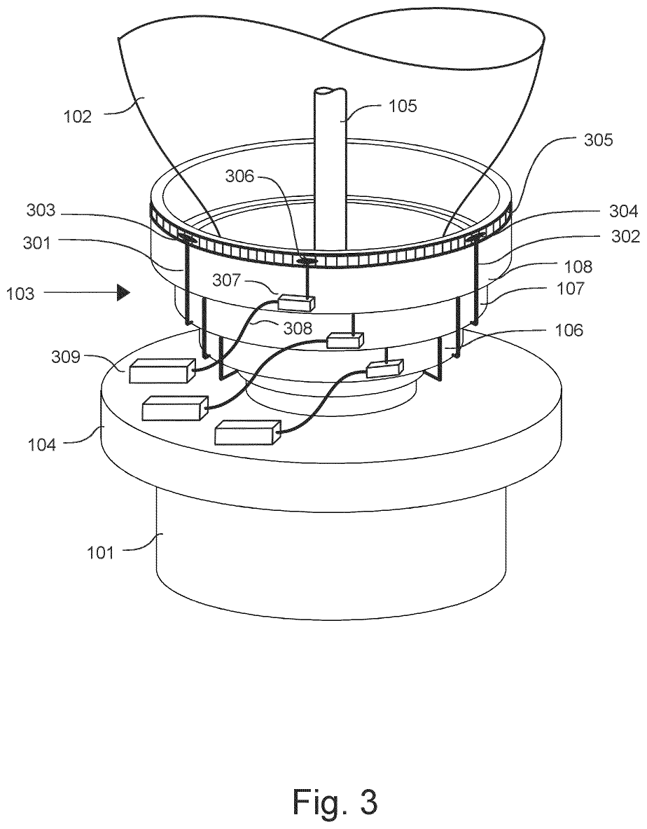

FIG. 3 the cooling device according to the invention as shown in FIG. 1 with a detailed representation of the mechanical components.

FIG. 1 shows a schematic 3D view of a film blowing head 101 for extruding a film tube 102 with a cooling device 103 mounted on the film blowing head 101. A cooling ring housing 104 is located between the cooling device 103 and the film blowing head 101, in which an external cooling ring for applying external cooling air to the film tube 102 and an internal cooling ring for applying internal cooling air to the film tube 102 are accommodated in a manner not shown in detail.

Inside the film tube 102 there is an internal exhaust pipe 105 for extracting the air blown in by the internal cooling ring. A constant internal pressure of the film tube is maintained via a control loop so that the bubble shape can also be kept stable in relation to the extraction speed.

A supporting air unit consisting of three concentrically arranged hollow cylinders 106, 107 and 108 is mounted on the cooling ring housing 104, whereby the three hollow cylinders have different diameters. The hollow cylinder with the smallest diameter 106 is placed on the cooling ring housing 104. The hollow cylinder with the medium diameter 107 is arranged concentrically above it, and the hollow cylinder with the largest diameter 108 in turn forms the end of the supporting air unit above it. The flow conditions created in this way between the three hollow cylinders 106, 107 and 108 arranged one above the other and the film bubble 102 can increase the cooling capacity on the outer wall of the film bubble 102.

To optimize the flow conditions, the axial spacing of the three bar cylinders can also be adjusted by motor. A detailed illustration of the mechanical components for motorized adjustment of the axial distances is shown in FIG. 3. The flow conditions at the cooling device according to the invention are explained in FIG. 2.

FIG. 2 shows a side view of the cooling device according to the invention.

Corresponding components from FIG. 1 are marked with the same reference numerals, so that reference can be made to the description of FIG. 1 in this respect. For better illustration, the view according to FIG. 2 is divided into two parts with reference to the vertical axis of the internal exhaust pipe 105. The left-hand side shows the cooling device when the blown film line is in operation, while the right-hand side shows the cooling device at rest.

During operation of the blown film system, the film tube 102 emerges from an annular nozzle gap of the film blowing head, which is not shown further, is blown onto a film bubble 102 in the manner shown and is drawn off in the transport direction y by a haul-off.

The cooling ring housing 104 transports cooling air to an outer cooling ring 201 and an inner cooling ring 202. The outer cooling ring directs the outer cooling air to the outer skin of the film bubble 102 via a baffle 203. The baffle 203 also divides the external cooling air so that the external cooling air hits the outer skin of the film bubble 102 in two opposite flow directions. This creates a negative pressure at certain points, which fixes the film bubble 102 between the outer cooling ring 201 and the inner cooling ring 202.

The height of the external cooling ring 201 can be adjusted by means of a linear drive 204, so that the exit point of the film bubble 102 above the external cooling ring 201 can be adapted to the properties of the respective film.

The support air unit described in FIG. 1 with the three hollow cylinders 106, 107 and 108 arranged one above the other is mounted on the external cooling ring 201. The three hollow cylinders can each be adjusted vertically by a motor. During operation of the blown film system, the three hollow cylinders are moved towards the film bubble (left side of FIG. 2).

When the blown film system is at rest, the outer cooling ring 201 is lowered via the linear drive 204. In addition, the three hollow cylinders 106, 107 and 108 are pushed together in the manner shown (right-hand side of FIG. 2).

FIG. 3 shows the cooling device according to the invention as shown in FIG. 1 with a detailed representation of the mechanical components for adjusting the 3 hollow cylinders 106, 107 and 108. Corresponding components from FIG. 1 are marked with the same reference numbers, so that reference can be made to the description of FIG. 1 in this respect.

In principle, the three hollow cylinders 106, 107 and 108 are each equipped with the same mechanical components for vertical adjustment. For the sake of simplicity, the description therefore only refers to the uppermost hollow cylinder 108. This also results in a corresponding mode of operation for the other two hollow cylinders 106 and 107.

The hollow cylinder 108 is supported on the underlying hollow cylinder 107 via three telescopic guides evenly distributed around the circumference, two of these 20 telescopic guides being visible and identified by reference numerals 301 and 302. Each of these telescopic guides comprises an integrated spindle which is drivable via a spindle gear wheel, two of these spindle gear wheels being visible and identified by the reference signs 303 and 304. Driving the spindle gear and thus also the spindle causes the telescopic guide in question to move together or apart.

A revolving chain 305 is mounted on the upper edge of the hollow cylinder 108, in which each of the three spindle sprockets engages, so that a movement of the chain 305 causes the respective spindle sprocket to be driven. This also drives the respective spindles in the same way, so that the hollow cylinder 108 can be precisely adjusted in the vertical direction.

The revolving chain 305 is again driven by a drive gear 306, which is driven by a stepper motor 309 via a gear unit 307 and a flexible shaft 308. The stepper motor 309 is in turn connected to a control unit for automatic operation of the blown film system. The hollow cylinders 106, 107, 108 are movable relative to the cooling ring blower 104, while the associated stepper motors 109 are fixedly connected to the cooling ring blower 104.

The flexible shafts allow the hollow cylinders 106, 107, 108 to be displaced relative to the stepper motors 109.

The revolving chain 305 thus forms a coupling element with respect to the telescopic guides 301 and 302, so that the telescopic guides 301 and 302 each effect the same adjustment path. Due to the operating distance between the hollow cylinder 108 and the film bubble 102 and the resulting air gap, a defined air flow is created for cooling and simultaneously stabilizing the film bubble. The coupled telescopic guides 301 and 302 ensure that the wooden cylinders 106, 107 and 108 remain centered and horizontally aligned along the entire adjustment path. This enables the operator to precisely adjust the support air unit to the bubble geometry both during machine set-up and during operation. This makes it possible to adjust small to very small air gaps between the support air unit and the blower geometry. Smaller air gaps in turn increase the flow velocity, whereby the local air pressure decreases. By increasing the flow velocity while simultaneously reducing the local air pressure, both the heat transfer and the bubble stability can be increased. In addition, the reduced local air pressure allows an earlier expansion of the film bubble within the air unit, whereby a larger film surface is available for heat dissipation.

At the same time, the control unit can be used to automatically set the operating distances between the supporting air unit 103 and the film bubble 102. When setting up the blown film line, for example, it is possible to set the operating distances automatically depending on the composition of the thermoplastic material. During operation of the blown film line, it is also possible to set the operating distances automatically depending on the position of the frost line of the film tube.

All of the above measures increase the cooling capacity of the cooling device while at the same time reducing bubble instability. In this way, the production speed and at the same time the reliability of the blown film line can be increased.

List of reference symbols

| | |
|---|---|
| 101 | Film blowing head |
| 102 | Film tube |
| 103 | Cooling device |
| 104 | Cooling ring fan |
| 105 | Internal exhaust air pipe |
| 106 | Hollow cylinder |
| 107 | Hollow cylinder |
| 108 | Hollow cylinder |
| 201 | External cooling ring |
| 202 | Inner cooling ring |
| 203 | Baffle |
| 204 | Linear drive |
| 301 | Telescopic guide |
| 302 | Telescopic guide |
| 303 | Spindle gear |
| 304 | Spindle gear |
| 305 | Revolving chain |
| 306 | Drive gear |
| 307 | Gear unit |
| 308 | Flexible shaft |
| 309 | Stepper motor |

1. Cooling device for a thermoplastic film tube,
with an external cooling ring surrounding the film tube, wherein the external cooling ring can be used to apply external cooling air to the outside of the film tube, and wherein the film tube can be formed into a film bubble following the external cooling ring,
with a supporting air unit for stabilizing the film bubble formed in connection with the external cooling ring, wherein the supporting air unit has at least one round body surrounding the film bubble for guiding the external cooling air between the round body and the film bubble, whereby an operating distance between the round body and the outer cooling ring can be adjusted in the axial direction of the film bubble,
the operating distance being adjustable by at least two driven lifting elements, and whereby the lifting elements are coupled to each other via a coupling element in such a way that the lifting elements effect the same adjustment path when adjusting the operating distance.

2. Cooling device according to claim 1, wherein an internal cooling ring is provided, with which the inside of the film tube can be supplied with internal cooling air.

3. Cooling device according to claim 1, wherein the round body consists of a concentrically arranged hollow cylinder, wherein three driven lifting elements are provided on the circumference of the hollow cylinder, wherein the coupling element consists of a drive chain driving the lifting elements together and wherein the drive chain can be driven by a stepper motor.

4. Blown film line for the production of plastic films or plastic film webs,
with at least one extruder,
with a film blowing head for extruding a thermoplastic film tube from a ring-shaped outlet nozzle,
with a cooling device downstream of the outlet nozzle according to claim 1 for the controlled transfer of the thermoplastic into a thermoelastic state along a frost line, with one haul-off and at least one winder, and
with a control unit for automatic operation of the blown film line.

5. Blown film line according to claim 4, wherein the operating distance of the supporting air unit integrated in the cooling device is automatically adjustable by the control unit.

6. Blown film line according to claim 4, wherein the operating distance of the supporting air unit integrated in the cooling device can be adjusted by the control unit during set-up of the blown film line as a function of the composition of the thermoplastic material.

7. Blown film line according to claim 4, wherein the operating distance of the supporting air unit integrated in the cooling device can be adjusted by the control unit during operation of the blown film line as a function of the position of the frost line of the film tube.

8. Cooling device according to claim 2, wherein the round body consists of a concentrically arranged hollow cylinder, wherein three driven lifting elements are provided on the circumference of the hollow cylinder, wherein the coupling element consists of a drive chain driving the lifting elements together and wherein the drive chain can be driven by a stepper motor.

9. Blown film line according to claim 5, wherein the operating distance of the supporting air unit integrated in the cooling device can be adjusted by the control unit during set-up of the blown film line as a function of the composition of the thermoplastic material.

10. Blown film line according to claim 5, wherein the operating distance of the supporting air unit integrated in the cooling device can be adjusted by the control unit during operation of the blown film line as a function of the position of the frost line of the film tube.

11. Blown film line according to claim 6, wherein the operating distance of the supporting air unit integrated in the cooling device can be adjusted by the control unit during operation of the blown film line as a function of the position of the frost line of the film tube.
